(19) United States
(12) Patent Application Publication
(10) Pub. No.: US 2013/0015263 A1
(43) Pub. Date: Jan. 17, 2013

(54) INTRODUCED TO A PORTABLE SAFETY SPRAYING DEVICE

(71) Applicant: Takashi NISHIMURA, SAO PAULO (BR)

(72) Inventor: Takashi NISHIMURA, SAO PAULO (BR)

(21) Appl. No.: 13/542,743

(22) Filed: Jul. 6, 2012

(30) Foreign Application Priority Data
Jul. 13, 2011 (BR) PI-1103599-4

(51) Int. Cl. B05B 9/03

(52) U.S. Cl. 239/154

(57) ABSTRACT

A portable safety spraying device includes a container of pressurized water and chemical product stored in a flexible pouch with quick-release coupler and is manufactured in a size and weight that is compatible with carrying a user. Nearly the entire volume of the container is held in or composes the pouch. A container lid includes a control valve for releasing the chemical product. The container receives pressurized clean water flowing from a stationary motorized pump through a long hose and is fed by water recycled by a motorized pump through an adjustable sequential valve. The valve operates to keep the hose pressure constant, independent of any pressure releasing action.

### CROSS-REFERENCE TO RELATED APPLICATION

The invention described and claimed hereinbelow is also described in Brazilian Patent Document PI-1103599-4, filed on Jul. 13, 2011. This Brazilian Patent Document, whose subject matter is incorporated here by reference, provides the basis for a claim of priority of invention under 35 U.S.C. 119(a)-(d).

### BACKGROUND OF THE INVENTION

The present invention relates to an improvement introduced to a portable safety spraying device, or, more precisely, an agricultural spraying apparatus.

As is well known, portable agricultural sprayers were created to treat small plantings with chemical products serving as insecticides, fungicides, fertilizers and for other purposes. The user carries the device, i.e., the portable agricultural sprayer with him/her, which consists of a reservoir of dissolved product that has a weight compatible with a user carrying it on his back, by hand, or on his/her waist. In addition to the reservoir is a manual pump (used to pressurize the reservoir), an outlet hose, and a gun with a trigger valve, and a tube equipped with a spray nozzle at the end.

There are sprayers in which the pump pressurizes the solution in a secondary chamber, with a constant influx of a large quantity of air in the upper part. The air is compressed when the solution is introduced and which keeps the gun spraying until it is necessary to pump again.

The solution of the chemical product in water, which fills the reservoir, constitutes a health hazard for the user, since potential small leaks or splashes during re-pressurization could come into contact with the user's skin. For intensive applications, there is a need for many consecutive re-pressurizations, which multiplies the probability of user contamination.

### SUMMARY OF THE INVENTION

The present invention overcomes the shortcomings of conventional sprayers, such as those mentioned above.

For example, the present invention provides an improved portable safety sprayer that is very efficient and productive for intensive treatment of plantings.

The inventive portable safety sprayer reduces the frequency with which the chemical product must be refilled while maintaining the pace of application.

Operating the inventive portable safety sprayer promotes a drastic reduction in operator fatigue, since the unique portable safety sprayer renders it unnecessary to pump manually because the source of pressurized water is external.

These advantages of the inventive portable safety sprayer are achieved with an improved portable safety sprayer of the type disclosed in a patent document entitled “Portable Safety Sprayer”, deposited with the National Institute of Intellectual Property [INPI] on May 16, 2011 under Registration No. 018119000018.

The inventive portable safety sprayer embodies a container of pressurized water and chemical product held in the flexible pouch, with the quick-release coupling, which has a size and weight compatible with a user carrying it and with nearly its entire volume occupied by the pouch. The container includes a lid that has a control valve for releasing the chemical product through which the container receives clean pressurized water coming from a stationary motor pump through a long hose. A motor pump has a water recycling feature with an adjustable sequential valve that keeps the pressure in the hose constant, independent of the releasing action.

### BRIEF DESCRIPTION OF THE DRAWINGS

Further features and advantages of the invention will become apparent from the description of embodiments that follows, with reference to the attached figures, wherein:

FIG. 1 shows a general view of the interconnected sprayer components of one embodiment of the inventive portable safety sprayer;

FIG. 2 shows a vertical cross-section of the pressure container depicted in FIG. 1;

FIG. 3 shows a diagram of the hydraulic system of the inventive portable safety sprayer;

FIG. 4 depicts the connected quick-release coupling, with a mechanically operated retention valve of the inventive portable safety sprayer;

FIG. 5 depicts the sequential valve that keeps the intake pressure constant in the inventive portable safety sprayer;

FIG. 6 depicts the trigger-activated two-way directional valve, which is normally closed, in the inventive portable safety sprayer; and,

FIG. 7 depicts variable restriction made possible by the inventive portable safety sprayer.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

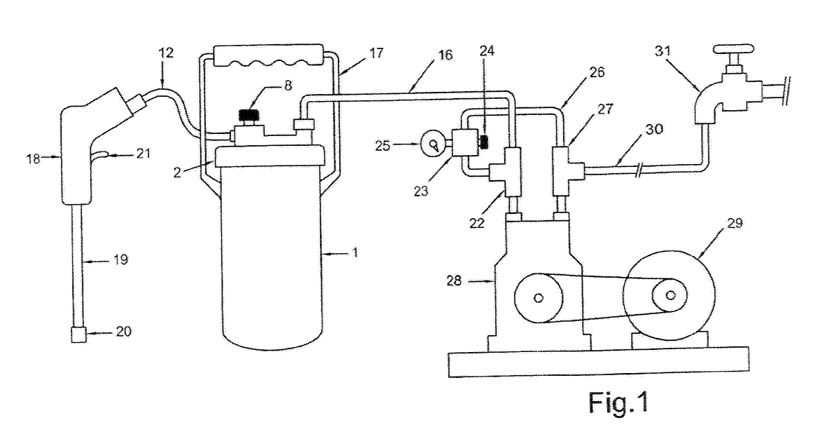

According to the embodiment presented in FIGS. 1-7, the portable safety sprayer is comprised of a container (1) of water and chemical product, having a pot-shaped configuration. An upper opening of container (1) receives a lid (2) in a threaded and sealed manner. Lid (2) is equipped on the upper part with a basically cylindrical protrusion (3), with a vertical hole (4) in contact with the inner side of the lid (2) and also concentric to a vertical protrusion (5), in which a quick-release coupling (6) is screwed onto a flexible pouch (7) that is equipped with a chemical product inside and available inside the container (1).

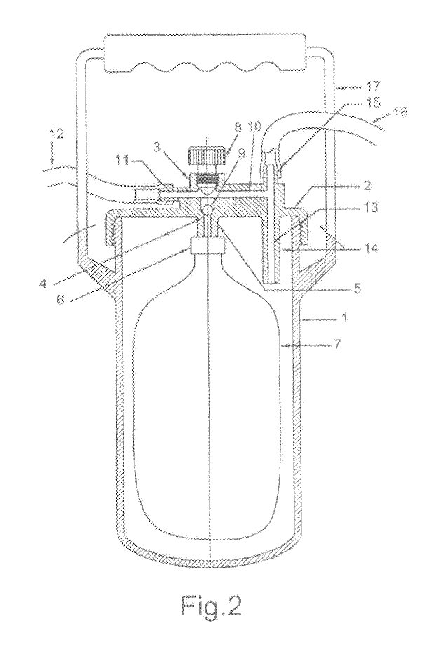

FIG. 2 shows a vertical cross-section of the container (1) assembly and the flexible pouch (7) filled with chemical product, thus occupying the greater portion of the interior of this container (1). Above this, the protrusion (3) has a thread to which a valve shaft (8) is screwed. A conical tip of valve shaft (8) fills the vertical hole (4), at a point on same above a reduced diameter of this hole (4), where a sphere (9) acts as a retention valve. Above this blockage and the sphere (9), the hole (4) is in contact with a horizontal hole (10), equipped with an end connection (11). The end connection (11) is for joining to a hose (12). At an end opposite end connection (11), hole (10) is in contact with a vertical hole (13), which runs through the lid (2) in a tubular extension (14). An opposite and upper end of tubular extension (14) defines a stem (15), to which is attached a hose (16). The container (1) has a strap (17) by which a user can carry the tank by hand or rings to which a belt may be attached, allowing it to be carried on the shoulder or waist.

The hose (12) is attached to a spray gun (18) (see FIG. 1), which has a tubular shaft (19) and a spraying nozzle (20), activated by a trigger (21) that is provided on the gun body (18).

The hose (16) is connected to a “T” connection (22) that forms part of an improved motor and pump assembly. “T” connection (22) has an outlet for the hose (16) and another outlet for an adjustable sequential valve (23), equipped with an adjustment knob (24) and manometer (25). A tube (26) that extends from the outlet valve (23) is in contact with a “T” connection (27). “T” connection (27) is connected to a suction port of a hydraulic pump (28). A connection (22) is made at the pressure port of the pump (28).

An electric motor or combustion engine (29) powers the pump (28), either directly driven or by belt, in which the “T” connection (27), in turn, is in contact, through a hose (30), with a source of clean water, as shown in FIG. 1 by a tap (31).

The hose (12) is short since it connects the container (1) to a spray gun (18) and both are carried by the user. Now the hose (16) can be long, with an extension facilitated by a hose take-up reel. The site of use of this device also can have innumerable pressurized clean water outlet points, fed by the connection (22). This arrangement provides the advantage of having the capacity to switch the connection of the hose (16) to the point closest to the work, as well as allowing several sprayers to be connected simultaneously.

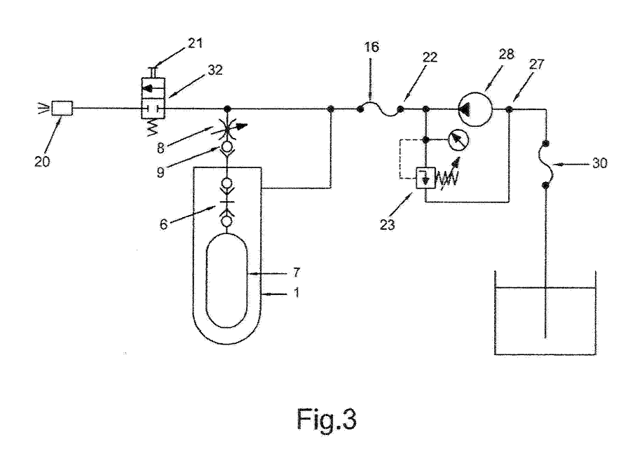

FIG. 3 shows a standardized diagram of the hydraulic system used in the inventive portable safety sprayer.

The quick-release coupling (6) for container (1), when connected, permits the passage of the chemical product contained in the pouch (7) to the valve (8) and the hole (10), impervious to the clean water surrounding it.

When disconnected, both the hole (4) of the protrusion (5) and the hole of the pouch (7) are closed, thereby preventing the chemical product from contaminating the clean water. Such design and construction ensures that there is no chance of an accident occurring to the user as a result of contamination by splattering or leakage of the poison, i.e., the chemical product.

As can be observed in FIGS. 1 and 2, the user carries the spray gun (18) and container (1) with its lid (2), filled almost exclusively with the chemical product, for example, at the start of the work day. For certain products, the ratio of water to product is 500:1, or even possibly more than 1000:1. This being so, for each load of chemical product, the user will spray almost 500 times or more of clean water. The external source of clean water is pressurized, and thus the user is not required to pump the product manually. This provides an advantage of eliminating this source of fatigue and increasing considerably spraying productivity.

The adjustable sequential valve (23) maintains clean water pressure, which is supplied through a hose (16) at a constant level and can be adjusted by the knob (24). This valve monitors the pressure by manometer (25) in a section of the hose (16) and returns any quantity of water that could elevate the pressure through the tube (26) to the suction port of the pump (28). The hydraulic pump (28) feeds a hose (16) with clean water at constant pressure, independent of the releasing action. The clean water reaches a hole (13) by compressing the packaging of concentrated chemical product and expelling the latter through a valve (4). The chemical product then passes through a hole (10) to the connection (11) of the hose (12).

That is, the pressure exerted on the container (1), which serves to compress the pouch (7), expels the chemical product through the quick-release coupling (6). The chemical product passes through the hole (4) and mixes with water which comes through the hole (10). The mixture of water with chemical product proceeds from the hole (10) up to the spray gun (18), along the length of hose (12). The mixture exits from this gun (18) through the spraying nozzle (20), when a directional valve (32), activated by a trigger (21), is opened (see FIG. 3).

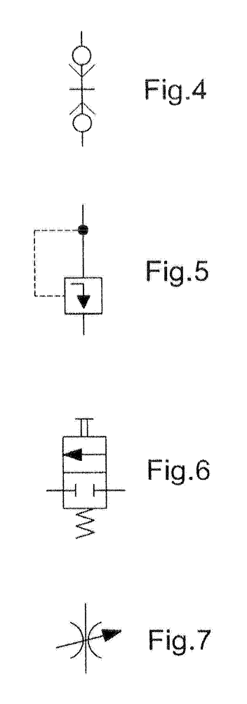

The quick-release coupling (6) is equipped with the retention valves shown in FIGS. 3 and 4. Dispersal of the outflow of the chemical product is controlled by a valve (8), using a knob.

If release of the chemical product through the spraying nozzle continues, dosing can be effected using a fixed setting of a valve (8), The sphere (9) forms a retention valve that blocks the passage of water in the direction of the pouch (7).

Normally the pouch (7) is supplied to the user, for example, a farmer, by the manufacturer of the chemical product. Preferably, the user returns the pouch to the supplier when empty, for refilling or eventual disposal, without the dangers posed by handling being transferred to the user.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A portable safety spraying device, comprising:
a container (1) for containing water and chemical product, the container (1) including an upper lid (2) formed with a vertical hole (4) in contact with a flexible pouch (7) of packaged chemical product, the flexible pouch (7) equipped with a quick-release coupling (6), and a mechanically operated retention valve, the retention valve formed with a hole (4) on a top of the upper lid (2), a thread on which top is screwed an emptying regulator valve (8) that acts on the hole (4), serving as a passageway for fluid through a horizontal hole (10) with a stem (11),
a hose (12), connected at one end to the stem 11 and at another end to a gun (18) equipped with a trigger valve (21), a shaft (19), and a spray nozzle (20),
wherein the horizontal hole (10) of lid (2) is in contact with a vertical hole (13) which runs through the lid (2), which vertical hole (13) extends with a tubular extension (14) below the horizontal hole (10) and with a stem (15) above the horizontal hole (10), wherein a hose (16) that comes from a source of pressurized clean water is connected to stem (15), wherein the pouch (7) is of a size slightly smaller than an interior space of the container (1) and wherein the container (1) is of a size and weight compatible with being carried or is equipped with a strap (17) that allows for hand carrying or is equipped with loops and straps that allow a user to carry it on his or her shoulders or waist.

2. The portable safety spraying device as set forth in claim 1, further comprising a hydraulic pump (28), powered by an electric motor or combustion engine (29), the hydraulic pump including a pressure port fastened to a connection (22), wherein connection (22) connects to the hose (16) for carrying clean pressurized water to the upper lid (2), and an adjustable sequential valve (23) with an adjustment knob (24) and manometer (25), wherein an outlet tube (26) of adjustable sequential valve (23) is in contact with a “T” joint (27) and wherein “T” joint (27) is connected to the suction port of the pump (28) and to a source of clean water.

3. The portable safety spraying device as set forth in claim 2, wherein adjustable sequential valve (23) maintains clean water pressure, which clean water pressure is supplied through hose (16) at a constant level, and is adjusted by the adjustment knob (24), wherein the manometer (25) monitors clean water pressure in the hose (16) and wherein the outlet tube (26) returns of any quantity of water that could increase pressure to the suction port of the pump (28).

4. The portable safety spraying device as set forth in claim 1, wherein the hose (16) is long and extendible by means of a hose pulley.
